(19) United States
(12) Patent Application Publication
(10) Pub. No.: US 2011/0187852 A1
(43) Pub. Date: Aug. 4, 2011

(54) CAMERA ADJUSTING SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/786,291

(22) Filed: May 24, 2010

(30) Foreign Application Priority Data
Feb. 2, 2010 (TW) 99102934

(51) Int. Cl. H04N 5/232

(52) U.S. Cl. 348/135; 348/207.11; 348/E05.042

(57) ABSTRACT

A camera adjusting system includes a first camera, a second camera, and a control apparatus. The first camera is used to monitor a locale. The second camera captures a three dimensional (3D) image of a head of a subject. The control apparatus receives the captured 3D image of the head of the subject and models a corresponding 3D model according to the captured 3D image. Compares the actual 3D model with a reference 3D model, to compute a compared result, and outputs a control signal to the first camera to adjust parameters of the first camera according to the compared result.

### CROSS-REFERENCE

Relevant subject matters are disclosed in three co-pending U.S. patent applications (Attorney Docket No. US29364, US30265, US31916) filed on the same date and having the same title, which are assigned to the same assignee as this patent application.

### BACKGROUND

1. Technical Field

The present disclosure relates to a camera adjusting system and a camera adjusting method.

2. Description of Related Art

Pan-tilt-zoom (PTZ) cameras are commonly used in security systems and, generally, are remotely controlled through the use of computers. To aim the camera and/or adjust the focus may require complex commands to be entered with a keyboard of the computer controlling the camera. This may also be slow and inconvenient. Therefore, there is room for improvement in the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic view of an embodiment of a camera adjusting system including a first camera, a control apparatus, a second camera, and a monitor, together with a subject and a locale.

FIG. 2 is a block diagram of a first embodiment of the control apparatus of FIG. 1.

FIG. 3 is a schematic view of a reference image of a head of the subject, together with the subject, the second camera, and the monitor.

FIG. 3A is a schematic view of an actual image of the head of the subject turned right, together with the subject, the second camera, and the monitor.

FIG. 3B is a schematic view of an actual image of the head of the subject turned left, together with the subject, the second camera, and the monitor.

FIG. 4A is a schematic view of an actual image of the head of the subject lowered, together with the subject, the second camera, and the monitor.

FIG. 4B is a schematic view of an actual image of the head of the subject raised, together with the subject, the second camera, and the monitor.

FIG. 5A is a schematic view of an actual image of the head of the subject moved forwards, together with the subject, the second camera, and the monitor.

FIG. 5B is a schematic view of an actual image of the head of the subject moved backwards, together with the subject, the second camera, and the monitor.

FIG. 6 is a block diagram of a second embodiment of the control apparatus of FIG. 1.

FIG. 7 is a flowchart of a first embodiment of a camera adjusting method.

FIG. 8 is a flowchart of a second embodiment of a camera adjusting method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

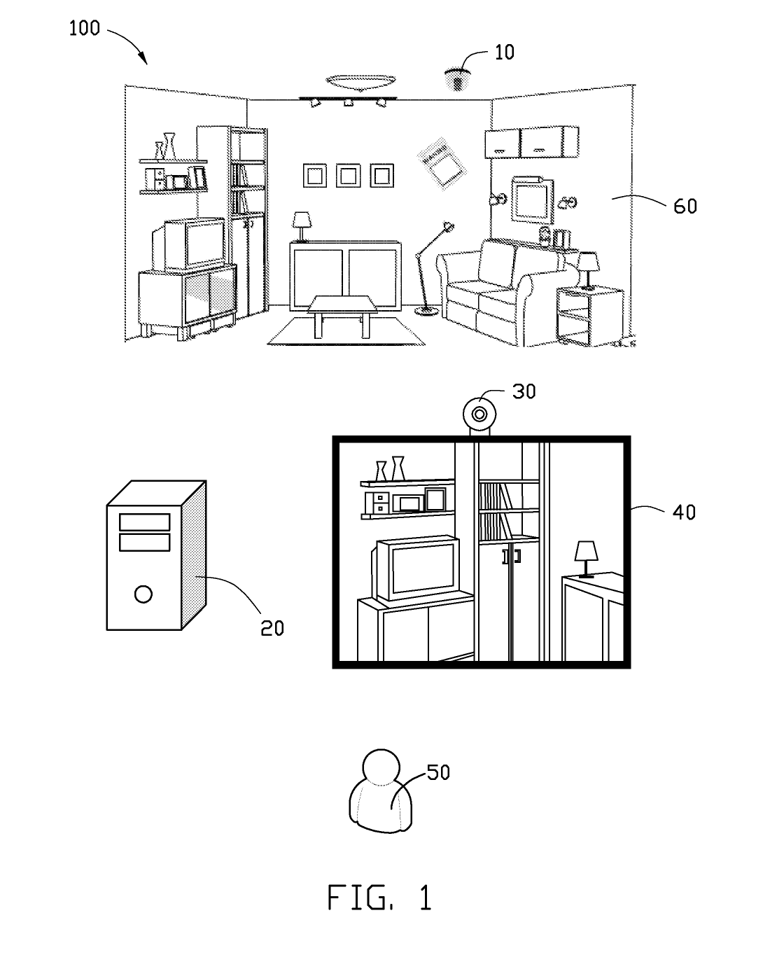

Referring to FIG. 1, an embodiment of a camera adjusting system 100 includes a first camera 10, a control apparatus 20, a second camera 30, and a monitor 40. The second camera 30 is a time-of-flight (TOF) camera.

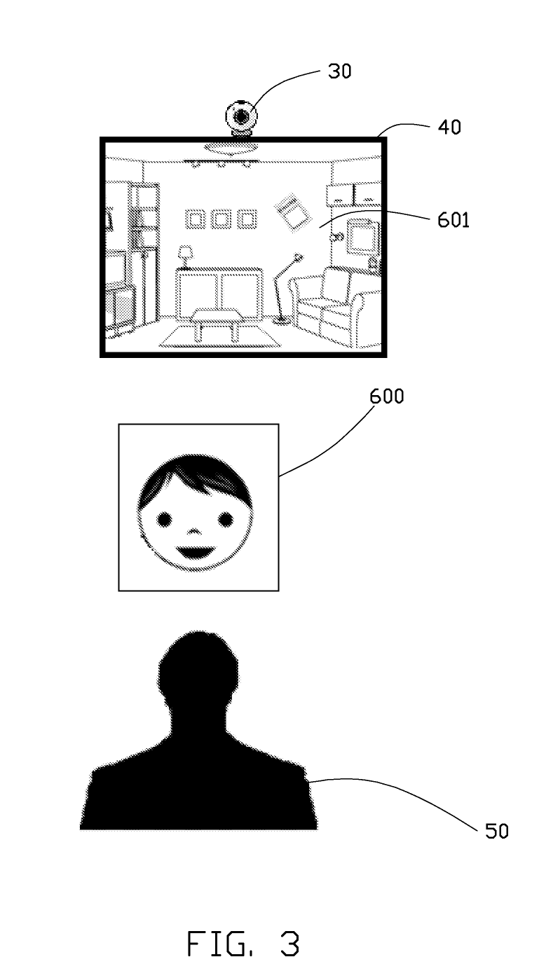

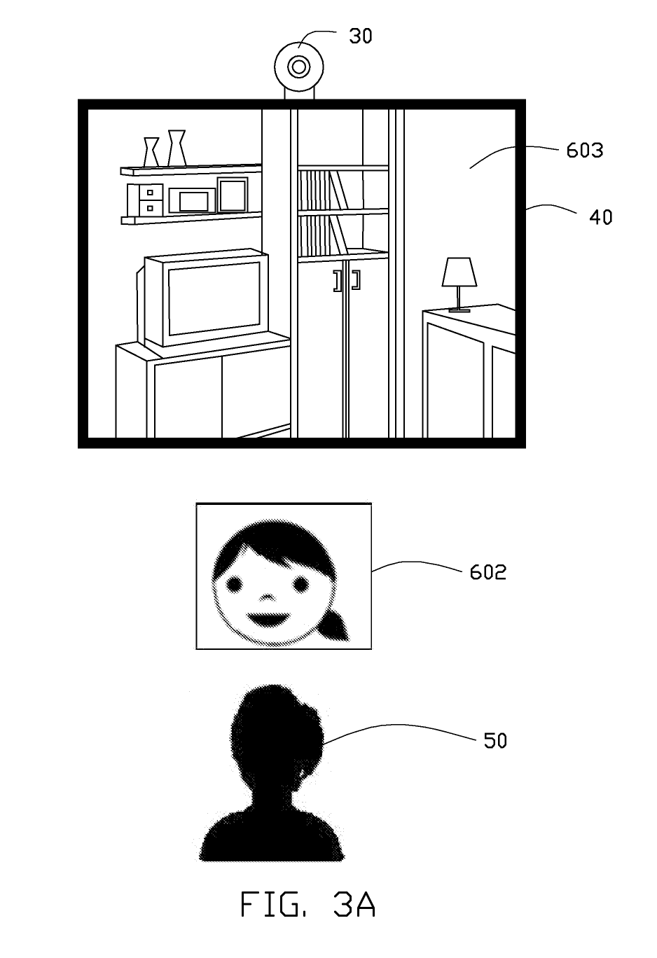

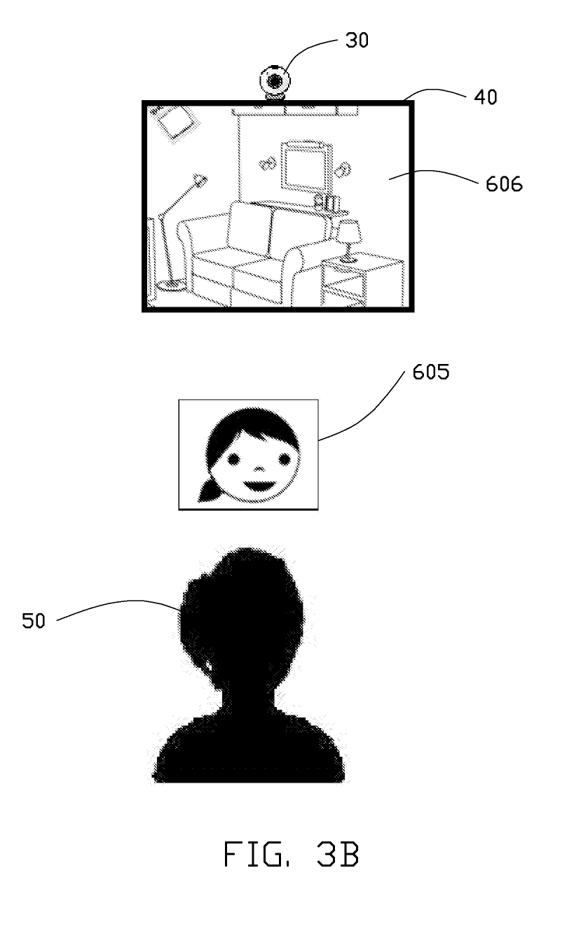

The first camera 10 is used to monitor a locale 60 such as a house. In one embodiment, the first camera 10 is fixed on an appropriate position of a ceiling of the locale 60. The monitor 40 is used to display the monitored area of the locale 60 monitored by the first camera 10. The second camera 30 is used to capture a three dimensional (3D) image of a head of a subject 50, and send the captured 3D image to the control apparatus 20. The control apparatus 20 receives the captured 3D image, models a corresponding 3D model according to the captured 3D image, and compares the actual 3D model with a reference 3D model 600 (see FIG. 3), then adjusts the parameters, such as the capturing angles and the zoom scales of the first camera 10, according to a compared result between the actual 3D model and the reference 3D model 600.

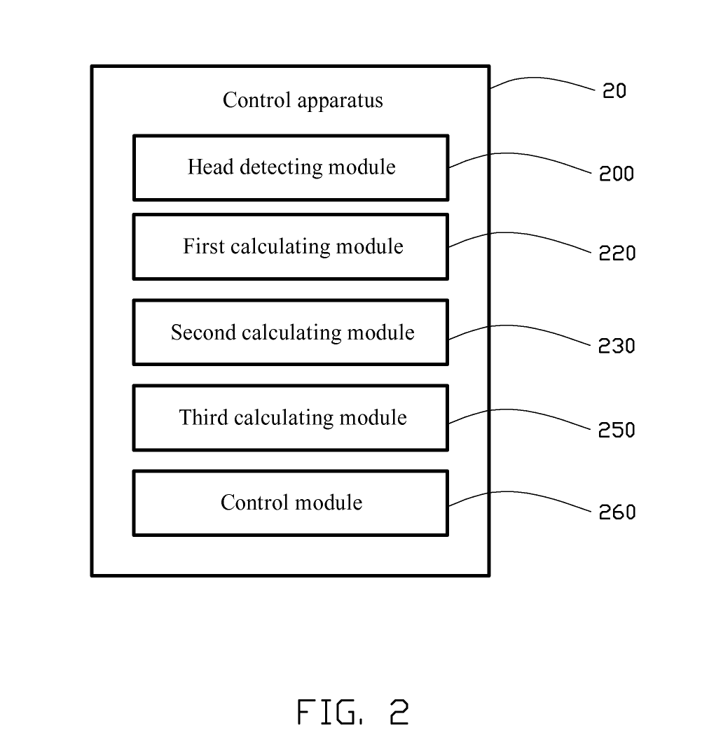

Referring to FIG. 2, the control apparatus 20 includes a head detecting module 200, a 3D modeling module 210, a first calculating module 220, a second calculating module 230, a third calculating module 250, and a control module 260.

The head detecting module 200 is used to receive the captured 3D image of the head of the subject 50 from the second camera 30. In one embodiment, the head detecting module 200 may use the AdaBoost algorithm to detect the captured image.

The 3D modeling module 210 is used to model a corresponding 3D model of the head of the subject 50 according to captured 3D image.

The first calculating module 220 is used to calculate the actual 3D model to compute a turned angle of the head of the subject 50. Referring to FIG. 3, the reference 3D model 600 is actually based on a captured image when the head of the subject 50 directly faces the second camera 30. The first calculating module 220 compares the actual 3D model with the reference 3D model 600, to compute the turned angle of the head of the subject 50. FIGS. 3A and 3B show two different actual 3D models 602 and 605 indicated the head of the subject 50 is turned right and left, respectively.

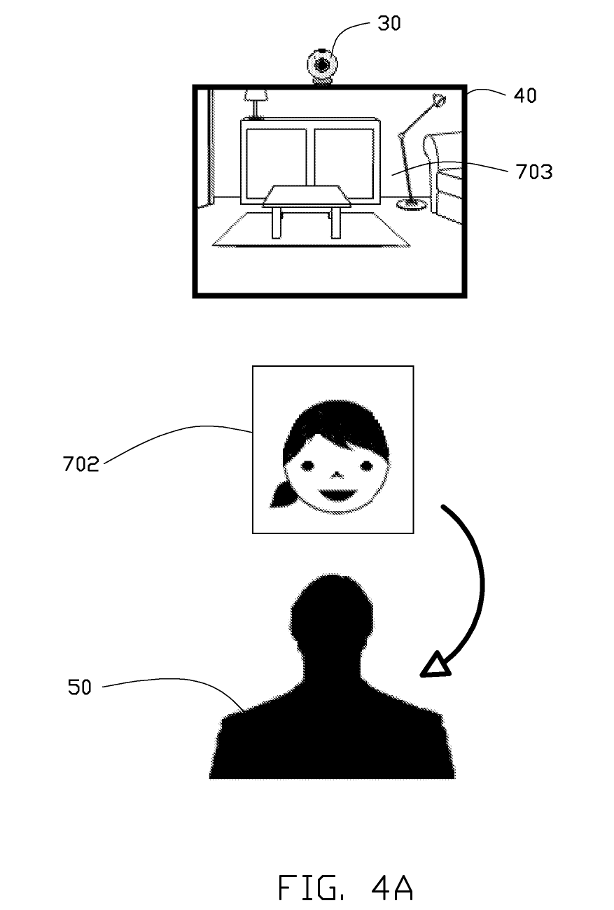

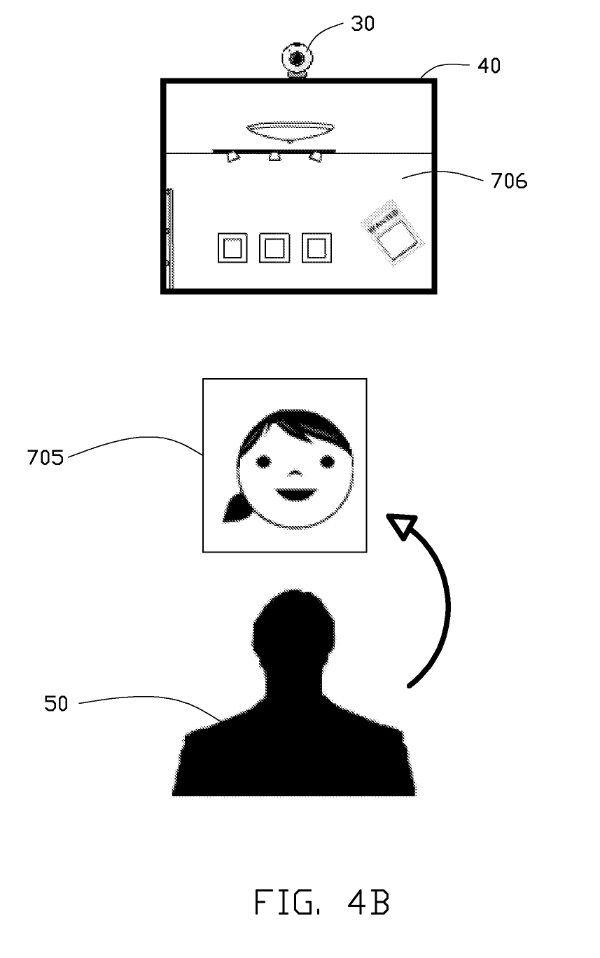

The second calculating module 230 is used to calculate the 3D model to compute a raised angle or a lowered angle of the head of the subject 50. In one embodiment, the second calculating module 230 compares the reference 3D model 600 of FIG. 3 with the actual 3D model, to compute the raised or lowered angle of the head of the subject 50. FIGS. 4A and 4B show two different actual 3D models 702 and 705 indicated the head is raised and lowered, respectively.

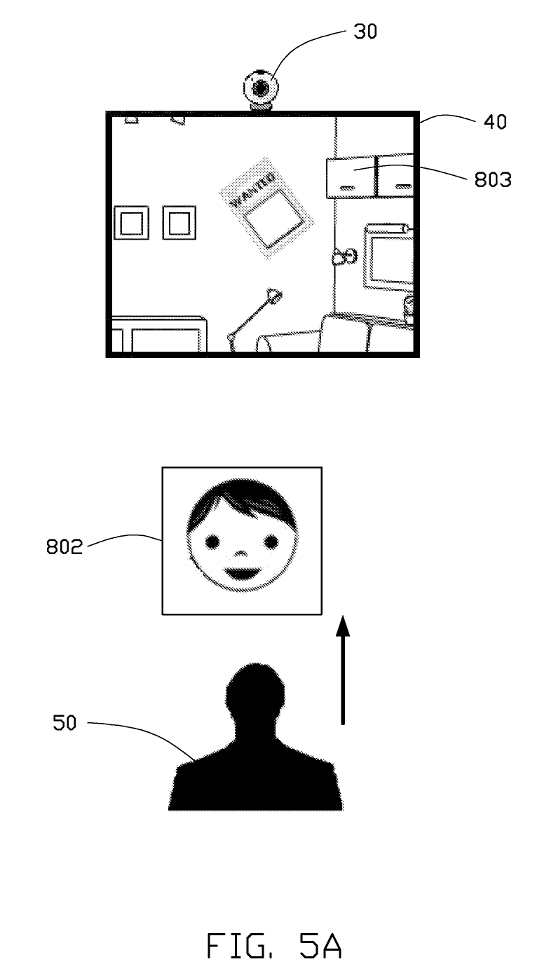

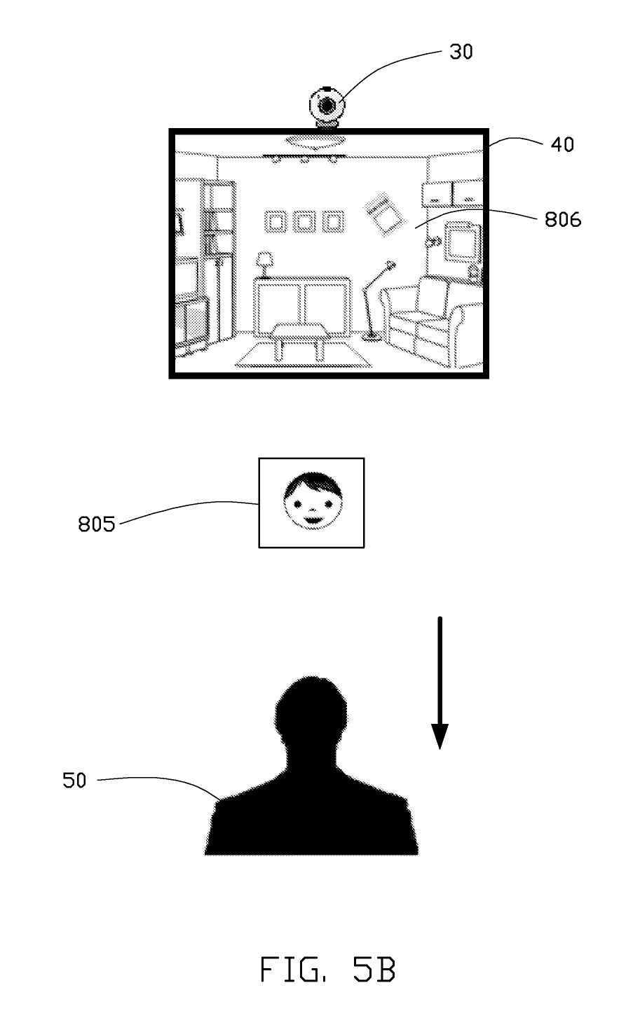

The third calculating module 250 is used to calculate the actual 3D model to compute a distance between the head of the subject 50 and the second camera 30. In one embodiment, the third calculating module 250 compares the reference 3D model 600 of FIG. 3 with the actual 3D model, to compute the distance between the head of the subject 50 and the second camera 30. FIGS. 5A and 5B show two actual 3D models 802 and 805 indicated the head is moved forwards and backwards, respectively. For example, the distance between the head of the subject 50 and the second camera 30 is fifty centimeters when the size ratio of the actual 3D model is the same as the size ratio of the reference 3D model 600 of FIG. 3.

In other embodiments, the control module 20 may further include other calculating modules to get other characteristics of the head of the subject 50, for example to calculate a number of times the subject 50 blinks their eyes on the actual 3D model.

The control module 260 receives the calculated results of the first to third calculating modules 220, 230, and 250, and correspondingly outputs control signals to the first camera 10 to adjust the parameters of the first camera 10. For example, when the first calculating module 220 calculates the head of the subject 50 is turned left ten degrees, the control module 260 outputs a first control signal to control the lens of first camera 10 to turn left ten degrees correspondingly. When the second calculating module 230 calculates the head of the subject 50 is raised ten degrees, the control module 260 outputs a second control signal to control the lens of first camera 10 to rotate up ten degrees correspondingly. When the third calculating module 250 calculates the distance between the second camera 30 and the head of the subject 50 is reduced by ten centimeters, the control module 260 outputs a third control signal to control the focus of the first camera 10 to be shortened correspondingly.

In other embodiments, the camera adjusting system 100 further includes a network module (not shown), which is used to transmit the control signals from the control module 260.

Three examples explaining the work process of the first to third calculating modules 220, 230, and 250 are sequentially given in the next paragraph. Referring to FIG. 3, the head of the subject 50 directly faces the second camera 30. The second camera 30 captures an actual 3D image of the head of the subject 50. The control apparatus 20 receives the actual 3D image to be a referring 3D model 600. At this time, the parameters of the first camera 10 are defaults and the monitor 40 displays an initial image 601 of the locale 60.

Referring to FIG. 3A, the head of the subject 50 is turned right. The second camera 30 captures a 3D image. The control apparatus 20 models a 3D model 602 according to the 3D image. The first calculating module 220 compares the reference 3D model 600 with the actual 3D model 602, to compute the corresponding turned angle of the head of the subject 50. The control module 260 receives the calculated result from the first calculating module 220 and outputs the first control signal to control the lens of the first camera 10 to turn a corresponding angle. After that, the monitor 40 displays a corresponding image 603 of the locale 60. Referring to FIG. 3B, the head of the subject 50 is turned left. The second camera 30 captures a 3D image. The control apparatus 20 models a 3D model 605 according to the 3D image. The first calculating module 220 compares the reference 3D model 600 with the actual 3D model 605, to compute the corresponding turned angle of the head of the subject 50. The control module 260 receives the calculated result from the first calculating module 220 and outputs the first control signal to control the lens of the first camera 10 to turn to a corresponding angle. After that, the monitor 40 displays a corresponding image 606 of the locale 60.

Referring to FIG. 4A, the head of the subject 50 is lowed. The second camera 30 captures a 3D image. The control apparatus 20 models a 3D model 702 according to the 3D image. The second calculating module 230 compares the reference 3D model 600 with the actual 3D model 702, to compute the corresponding lowered angle of the head of the subject 50. The control module 260 receives the calculated result from the second calculating module 230 and outputs the second control signal to control the lens of the first camera 10 to lower to a corresponding angle. After that, the monitor 40 displays a corresponding image 703 of the locale 60. Referring to FIG. 4B, the head of the subject 50 is raised. The second camera 30 captures a 3D image. The control apparatus 20 models a 3D model 705 according to the 3D image. The second calculating module 230 compares the reference 3D model 600 with the actual 3D model 705, to compute the corresponding raised angle of the head of the subject 50. The control module 260 receives the calculated result from the second calculating module 230 and outputs the second control signal to control the lens of the first camera 10 to rise to a corresponding angle. After that, the monitor 40 displays a corresponding image 706 of the locale 60.

Referring to FIG. 5A, the head of the subject 50 moves forwards. The second camera 30 captures a 3D image. The control apparatus 20 models a 3D model 802 according to the 3D image. The third calculating module 250 compares the reference 3D model 600 with the actual 3D model 802, to compute the corresponding distance of the head of the subject 50. The control module 260 receives the calculated result from the third calculating module 250 and outputs the third control signal to control the focus of the lens of the first camera 10 to be enlarged correspondingly. After that, the monitor 40 displays a corresponding image 803 of the locale 60. Referring to FIG. 5B, the head of the subject 50 moves backwards. The second camera 30 captures a 3D image. The control apparatus 20 models a 3D model 805 according to the 3D image. The third calculating module 250 compares the reference 3D model 600 with the actual 3D model 805, to compute the corresponding distance of the head of the subject 50. The control module 260 receives the calculated result from the third calculating module 250 and outputs the third control signal to control the focus of the lens of the first camera 10 to be shortened correspondingly. After that, the monitor 40 displays a corresponding image 806 of the locale 60.

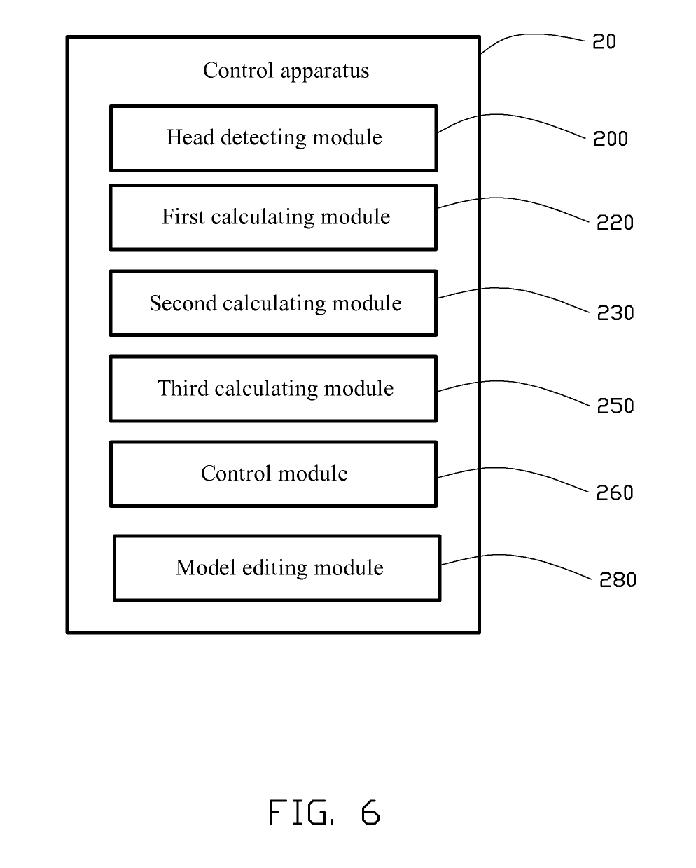

Referring to FIG. 6, a second embodiment of the control apparatus 22 includes a head detecting module 200, a 3D modeling module 210, a first calculating module 220, a second calculating module 230, a third calculating module 250, a control module 260, and a model editing module 280. The model editing module 280 is used to edit the actual 3D model by the 3D modeling module 210 to simplify the 3D model. For example, the model editing module 280 cuts the shoulders or neck of the 3D model to leave only the head of the 3D model. After editing the 3D model, the calculating processes of the first calculating module 220, the second calculating module 230, and the third calculating module 250 can be simpler.

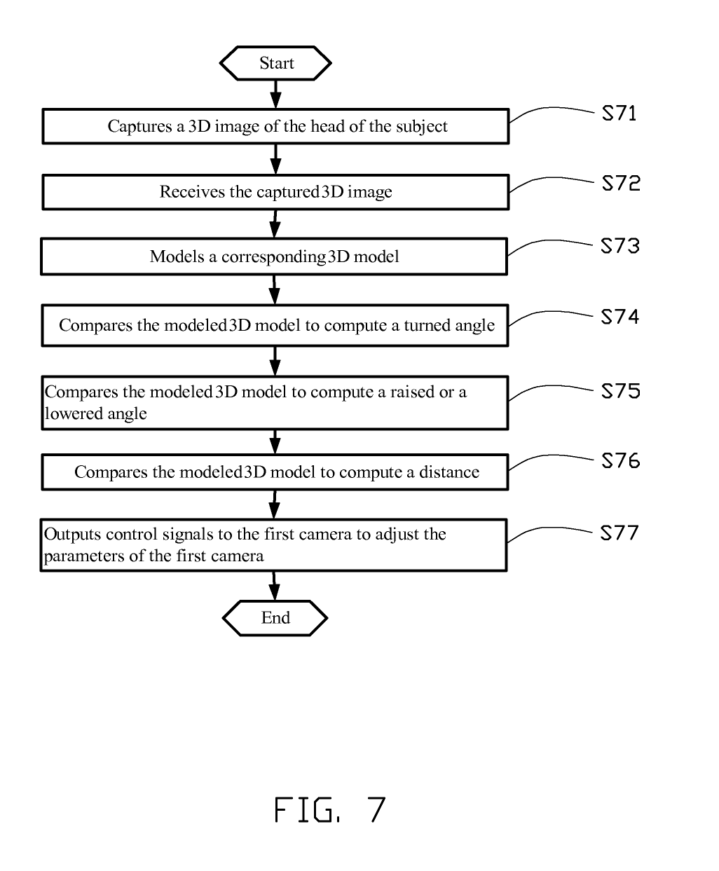

Referring to FIG. 7, an embodiment of a camera adjusting method includes the following steps.

In step 71, the second camera 30 captures a 3D image of the head of the subject 50.

In step S72, the head detecting modules 200 receives the captured 3D image from the second camera 30. The head detecting module 200 may use the AdaBoost algorithm to detect the captured image.

In step S73, the 3D modeling module 210 models a corresponding 3D model of the head of the subject 50 according to the captured 3D image.

In step S74, the first calculating module 220 compares the actual 3D model with the reference 3D model 600, to compute a first result of a turned angle of the head of the subject 50.

In step S75, the second calculating module 230 compares the actual 3D model with the reference 3D model 600, to compute a second result of a raised or a lowered angle of the head of the subject 50.

In step S76, the third calculating module 250 compares the actual 3D model with the reference 3D model 600, to compute a third result of a distance between the head of the subject 50 and the second camera 30.

In step S77, the control module 260 receives the results of the first to third calculating modules 220, 230, and 250, and correspondingly outputs control signals to the first camera 10 to adjust the parameters of the first camera 10.

In other embodiments, the three steps of S74, S75, and S76 can be executed in any other orders, such as S75 firstly, S76 secondly, and S74 lastly.

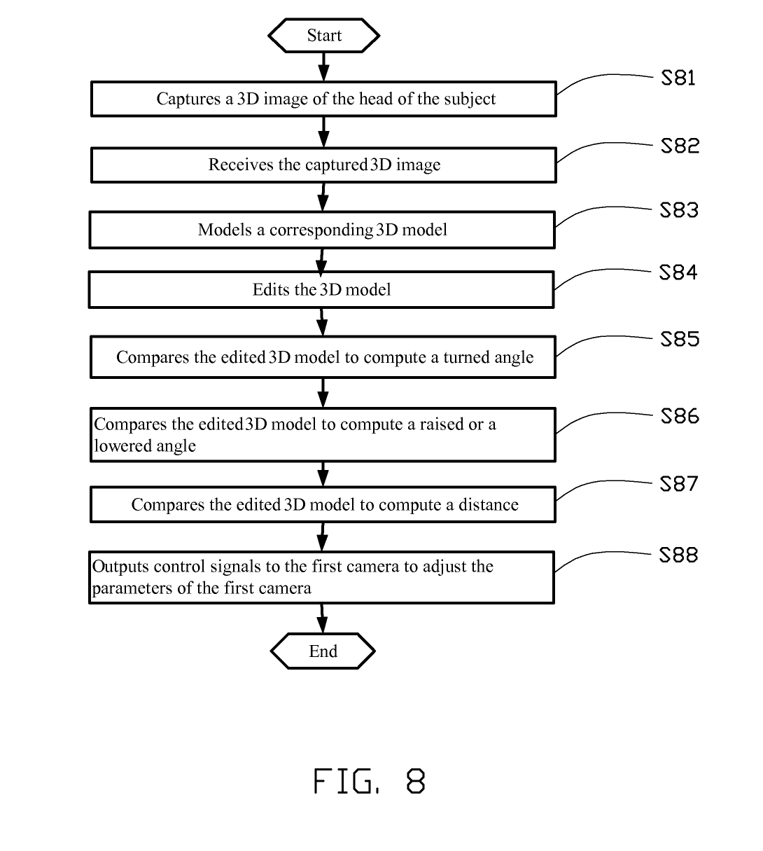

Referring to FIG. 8, a second embodiment of a camera adjusting method includes the following steps.

In step 81, the second camera 30 captures a 3D image of the head of the subject 50.

In step S82, the head detecting modules 200 receives the captured 3D image from the second camera 30. The head detecting module 200 may use the AdaBoost algorithm to detect the captured image.

In step S83, the 3D modeling module 210 models a corresponding 3D model of the head of the subject 50 according to captured 3D image.

In step S84, the model editing module 280 edits the actual 3D model by the 3D modeling module 210 to simplify the 3D model.

In step S85, the first calculating module 220 compares the edited 3D model with the reference 3D model 600, to compute a first result of a turned angle of the head of the subject 50.

In step S86, the second calculating module 230 compares the edited 3D model with the reference 3D model 600, to compute a second result of a raised or a lowered angle of the head of the subject 50.

In step S87, the third calculating module 250 compares the edited 3D model with the reference 3D model 600, to compute a third result of a distance between the head of the subject 50 and the second camera 30.

In step S88, the control module 260 receives the results of the first to third calculating modules 220, 230, and 250, and correspondingly outputs control signals to the first camera 10 to adjust the parameters of the first camera 10.

In other embodiments, the three steps of S85, S86, and S87 can be executed in any other orders, such as S86 firstly, S87 secondly, and S85 lastly.

The camera adjusting method used in the camera adjusting system 100 can control the first camera 10 according to the action of the head of the subject 50, which is very easily controlled.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A camera adjusting system, comprising:
a first camera to monitor a locale;
a monitor to display the monitored area of the locale monitored by the first camera;
a second camera to capture a three dimensional (3D) image of a head of a subject;
wherein the second camera is a time-of-flight (TOF) camera; and
a control apparatus to receive the captured 3D image of the head of the subject, model a corresponding 3D model according to the captured 3D image, and compare the actual 3D model with a reference 3D model to compute a compared result, and output a control signal to the first camera to adjust parameters of the first camera according to the compared result; wherein the parameters of the first camera comprise capturing angles and zoom scales.

2. The camera adjusting system of claim 1, wherein the control apparatus comprises a head detecting module, a 3D modeling module, a calculating module, and a control module, the head detecting module receives the captured 3D image of the head of the subject, the 3D modeling module models the corresponding 3D model of the head of the subject according to the captured 3D image, the calculating module compares the actual 3D model with the reference 3D model to compute a turned angle of the head of the subject, the control module outputs the control signal to control a lens of the first camera to correspondingly rotate left or right according to the computed turned angle.

3. The camera adjusting system of claim 1, wherein the control apparatus comprises a head detecting module, a 3D modeling module, a calculating module, and a control module, the head detecting module receives the captured 3D image of the head of the subject, the 3D modeling module models the corresponding 3D model of the head of the subject according to captured 3D image, the calculating module compares the actual 3D model with the reference 3D model to compute a raised or lowered angle of the head of the subject, the control module outputs the control signal to control a lens of the first camera to correspondingly rotate up or down according to the computed raised or lowered angle.

4. The camera adjusting system of claim 1, wherein the control apparatus comprises a head detecting module, a 3D modeling module, a calculating module, and a control module, the head detecting module receives the captured 3D image of the head of the subject, the 3D modeling module models the corresponding 3D model of the head of the subject according to captured 3D image, the calculating module compares the actual 3D model with the reference 3D model to compute a distance between the second camera and the head of the subject, the control module outputs the control signal to control the first camera to correspondingly adjust the focus of first camera according to the computed distance.

5. The camera adjusting system of claim 1, wherein the first camera is fixed on a position of the locale.

6. A camera adjusting method to adjust parameters of a first camera according to a three dimensional (3D) image of a head of a subject captured by a second camera, the camera adjusting method comprising:
capturing a 3D image of the head of the subject by the second camera; wherein the second camera is a time-of-flight (TOF) camera;
receiving the captured 3D image of the head of the subject from the second camera;
modeling a corresponding 3D model of the head of the subject according to the captured 3D image;
comparing the actual 3D model with a reference 3D model to compute a compared result; and
outputting a control signal to the first camera to adjust parameters of the first camera according to the compared result; wherein the parameters of the first camera comprise capturing angles and zoom scales.

7. The camera adjusting method of claim 6, wherein in the comparing step, comparing the actual 3D model with the reference 3D model computes a turned angle of the head of the subject; and
wherein in the outputting step, the control signal controls a lens of the first camera to correspondingly rotate left or right according to the computed turned angle.

8. The camera adjusting method of claim 6, wherein in the comparing step, comparing the actual 3D model with the reference 3D model computes a raised or lowered angle of the head of the subject; and
wherein in the outputting step, the control signal controls the first camera to correspondingly rotate up or down according to the computed raised or lowered angle.

9. The camera adjusting method of claim 6, wherein in the comparing step, comparing the actual 3D model with the reference 3D model computes a distance between the second camera and the head of the subject; and
wherein in the outputting step, the control signal controls the focus of the first camera to correspondingly be shorten or lengthen according to the computed distance.

10. The camera adjusting method of claim 6, wherein between the modeling step and the comparing step, further comprises:
editing the actual 3D model to simplify the 3D model.
